(19) United States
(12) Patent Application Publication
(10) Pub. No.: US 2007/0097238 A1
(43) Pub. Date: May 3, 2007

(54) METHOD FOR RAPIDLY CHANGING THE COLOR OF A LIGHT SOURCE AND IMAGE APPARATUS USING THE SAME

(75) Inventor: Shu-Chuan Li, HsinChu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASIA OPTICAL CO., INC., Taichung (TW)

(21) Appl. No.: 11/539,185

(22) Filed: Oct. 6, 2006

(30) Foreign Application Priority Data
Oct. 6, 2005 (TW) 94134942

(51) Int. Cl. H04N 9/04

(52) U.S. Cl. 348/268

(57) ABSTRACT

A method for rapidly changing the color of a light source is provided. An image apparatus comprising at least one light mask and one voltage converter is provided. The voltage converter applies a first voltage to the light mask to show a first color. A control signal is sent to the voltage converter and the voltage converter applies a second voltage greater than the first voltage to the light mask to show a second color or a third voltage less than the first voltage to the light mask to show a third color.

### BACKGROUND OF THE INVENTION

1. Field of the Invention

The present invention relates to an image apparatus, and in particular relates to an image apparatus using a method for rapidly changing the color of a light source.

2. Description of the Related Art

A cameraman may require different colors of light to create distinctive scenes. Currently, different color masks or lenses are placed in front of a light source to provide illumination of different colors, whereas, an object is illuminated using a fixed color of light. Additionally, background colors/effects can be changed by image processing.

The method requiring changing masks (or lenses) or light sources repeatedly to illuminate with different colors of lights is time-consuming and inconvenient while image processing may distort pictures and result in larger sizes of image file sizes and require more time to save.

Thus, the invention provides a method for rapidly changing the color of a light source without masks or image processing.

### BRIEF SUMMARY OF THE INVENTION

An image apparatus comprising a light mask, a voltage converter, and a processor is provided. The light mask shows different colors based on applied voltages. The voltage converter applies a first voltage to the light mask to show a first color. The processor sends a control signal to the voltage converter and enables the voltage converter to apply a second voltage greater than the first voltage to the light mask to show a second color or a third voltage less than the first voltage to the light mask to show a third color.

A method for rapidly changing the color of a light source is provided. In an embodiment, an image apparatus comprising at least one light mask and one voltage converter is provided. The voltage converter applies a first voltage to the light mask to show a first color. A control signal is sent to the voltage converter and the voltage converter applies a second voltage greater than the first voltage to the light mask to show a second color or a third voltage less than the first voltage to the light mask to show a third color.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A and 1B are schematic views of an example of rapidly changing the color of a light source;

FIG. 2 is a schematic view of an embodiment of the architecture of an image apparatus;

FIG. 3 is a curve of transformation of voltage and colors; and

FIG. 4 is a schematic view of an embodiment of a method for rapidly changing the color of a light source.

### DETAILED DESCRIPTION OF THE INVENTION

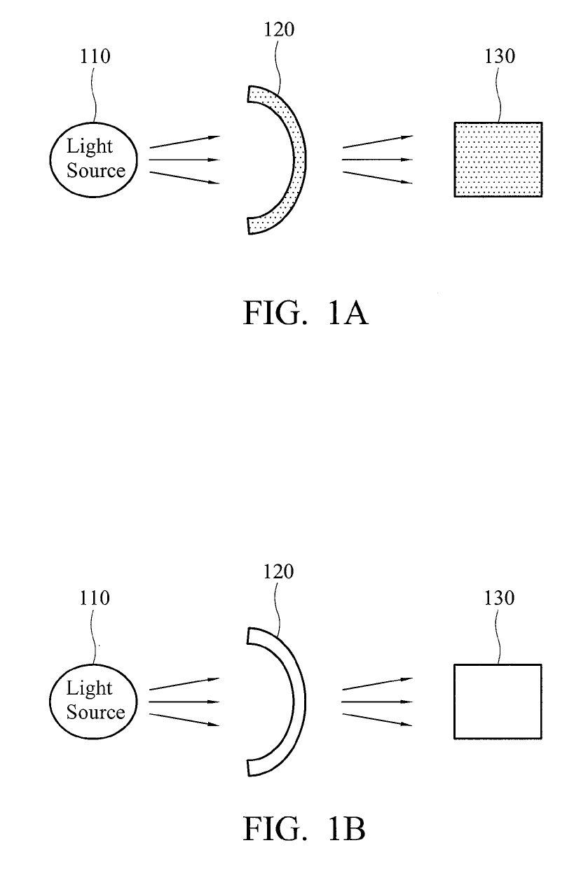

Several exemplary embodiments of the invention are described with reference to FIGS. 1 through 4, which generally relate to an image apparatus using a method for rapidly changing the color of a light source. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention discloses a method for rapidly changing the color of a light source and an image apparatus using the same.

An image apparatus of the invention utilizes electrochromic glass placed in front of a light source and an electronic circuit control unit to change colors of the glass by voltage variation.

Ionization states of ionic compound of electrochromic glass are changed by voltage variation, indicating transmittance or display colors are adjusted according to the amount of current passed to transform transparent glass to opaque or other colors. A method for electrochromic glass puts dispersive and distributed liquid crystal of compounds in the space between two glass substrates coated with transparent conductive films. The two conductive films server as two planar electrodes. Liquid crystal inside the electrochromic glass are irregularly arranged at the state of nature (power failure without applying an electromagnetic field (EMF)) and a refractive index of the liquid crystal is less than that of the compounds, in which incidence light is scattered over the compounds to show a creamy white color, such that the electrochromic glass shows an opaque or a fixed color. When EMF is applied (electrifying), the dispersive and distributed liquid crystal of compounds is rearranged regularly such that the refractive index of the liquid crystal equals that of the compounds, allowing that incidence light can pass through the electrochromic glass, changed as transparent or to another color. Additionally, transmittance and a desired color of the electrochromic glass can be controlled according to the applied voltage.

Further, materials of coated films of electrochromic glass can be metallic oxide films (WO₃, for example). The metallic oxide film is adjacent to an electrolyte neighboring lithium (Li) metals releasing Li ion to form a sandwich structure of “electrochromic glass”-“film”-“electrolyte”-“Li”. The conductive glass transmits electrons carrying negative charge, the Li metals provide Li ion carrying positive charge, and the electrolyte bridges the Li ion. When a negative voltage is applied to the electrochromic glass, the electrons are injected to the films (WO₃), and the films change to blue color.

FIGS. 1A and 1B are schematic views of an example of rapidly changing the color of a light source. Originally, light mask 120 does not carry any voltage or carry a fixed voltage (first voltage) to show transparent. As shown in FIG. 1A, when a voltage is applied to light mask 120 to carry a fixed voltage (a second voltage) or increase or decrease the fist voltage to another voltage (a second voltage), and thereby the light mask 120 shows a color (blue, for example). Thus, when light emitted by light source 110 passes through light mask 120 to be shined on an object 130, object 130 shows a color (blue) identical to that of light mask 120. Referring to FIG. 1B, when a voltage is applied to light mask 120 to carry a fixed voltage (a third voltage) or increase or decrease the fist voltage to another voltage (a third voltage), and thereby the light mask 120 shows another color (red, for example). Thus, when light emitted by light source 110 passes through light mask 120 to be shined on an object 130, object 130 shows a color (red) identical to that of light mask 120.

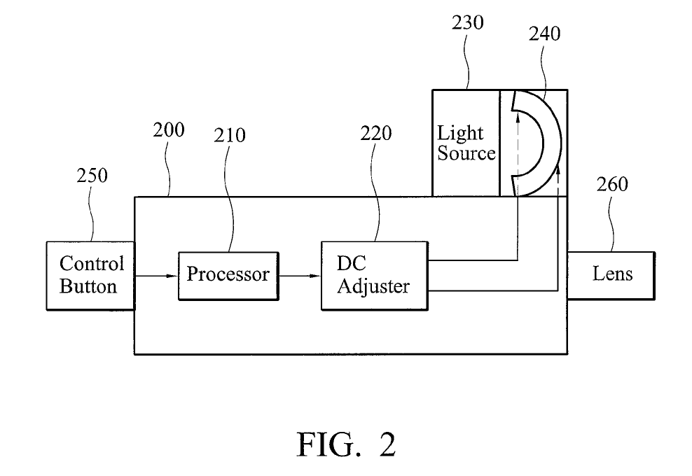

FIG. 2 is a schematic view of an embodiment of the architecture of an image apparatus.

An image apparatus (such as a video camera, a digital camera, and the like) 200 of the invention comprises a processor 210, a direct current (DC) adjuster 220, a light source 230, a light mask (formed by electrochromic glass) 240, a control button 250, and a lens 260. Light mask 240 is composed of a positive conductive plate, a negative conductive plate, and ionic compound between the plates, and carries a fixed voltage (≧0V) to show transparent or a predetermined color. Additionally, light mask 240 is located in front of light source 230 to completely or partially cover light source 230.

When a light source for a scene is required, control button 250 is enabled to send a control signal to processor 210. Processor 210 then sends a corresponding signal to DC adjuster 220 according to the control signal. DC adjuster 220 decreases or increases the carried voltage of light mask 240 to another fixed voltage according to the signal, enabling the positive and negative conductive plates to affect the ionic compound to generate an EMF to change arrangement directions or ionization states of the ionic compound, thereby changing the color of the electrochromic glass.

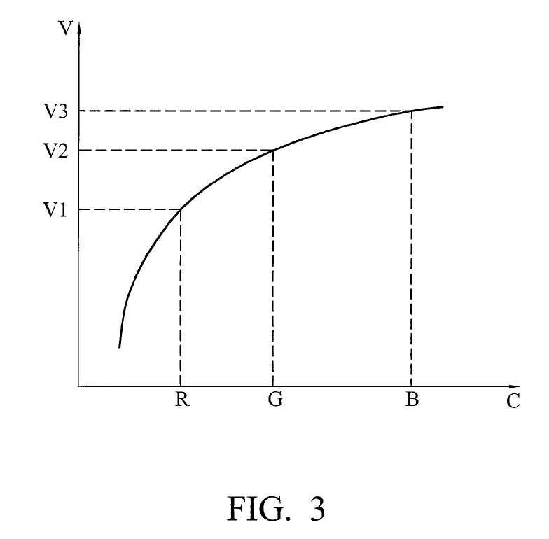

FIG. 3 is a curve of transformation of voltage and colors, where the X axis represents colors and the Y axis represents voltages. Referring to FIG. 3, an electronic circuit control unit applies a voltage corresponding to a desired color according to the transformation curve to change the color of a light mask, thereby changing the color of the light mask. Light mask 240, for example, does not originally carry any voltage (V=0) but shows red when DC adjuster 220 applies V1 volt (V) thereto (below 1.5 V, for example), green when DC adjuster 220 applies V2 V thereto (between 1.9 V and 2.8 V, for example), and blue when DC adjuster 220 applies V3 V (beyond 3.2 V, for example), and the process repeats to alternate between different colors.

Additionally, light mask 240 can also be located in front of lens 260, achieving the same effects like the location in front of light source 230.

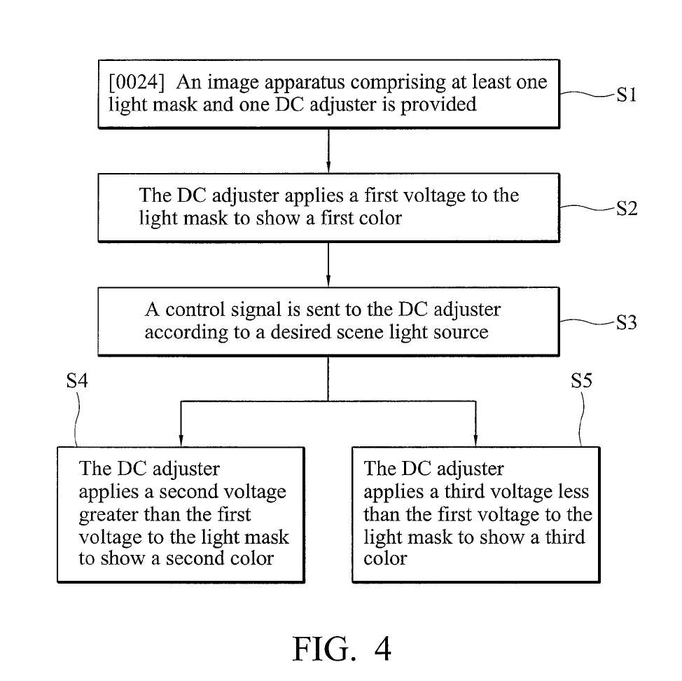

FIG. 4 is a schematic view of an embodiment of a method for rapidly changing the color of a light source.

An image apparatus comprising at least one light mask and one DC adjuster is provided (step S1). The DC adjuster applies a first voltage to the light mask to show a first color (step S2). A control signal is sent to the DC adjuster according to a desired scene light source (step S3). The DC adjuster applies a second voltage greater than the first voltage to the light mask to show a second color (step S4) or a third voltage less than the first voltage to the light mask to show a third color (step S5).

A method for rapidly changing the color of a light source of the invention can appropriately adjust desired voltage to enable the electrochromic glass located in front of a light source or a lens to show a desired color, thereby enabling an object to show the desired color.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image apparatus, comprising:
a light mask, capable of showing different colors based on applied voltages;
a voltage converter, coupled to the light mask, capable of applying a first voltage to the light mask to show a first color; and
a processor, coupled to the voltage converter, capable of sending a control signal to the voltage converter and, according to the control signal, enabling the voltage converter to apply a second voltage greater than the first voltage to the light mask to show a second color or a third voltage less than the first voltage to the light mask to show a third color.

2. The image apparatus as claimed in claim 1, wherein the light mask is a piece of discoloration glass, composed of a positive conductive plate, a negative conductive plate, and ionic compound between the plates.

3. The image apparatus as claimed in claim 2, wherein the voltage converter is a DC adjuster, applying the second or third voltage to the light mask to generate an electromagnetic field (EMF) to change arrangement directions or ionization states of the ionic compound.

4. The image apparatus as claimed in claim 1, further comprising a lens, wherein the light mask is located at one side of the lens to completely or partially cover the lens.

5. The image apparatus as claimed in claim 1, further comprising a light source or a photoflash, wherein the light mask is located at one side of the light source or the photoflash to completely or partially cover the lens.

6. A method for rapidly changing the color of a light source, comprising:
providing an image apparatus, comprising at least one light mask and one voltage converter, wherein the voltage converter applies a first voltage to the light mask to show a first color;
sending a control signal to the voltage converter; and
applying, using the voltage converter, a second voltage greater than the first voltage to the light mask to show a second color or a third voltage less than the first voltage to the light mask to show a third color.

7. The method for rapidly changing the color of a light source as claimed in claim 6, wherein the light mask is a piece of discoloration glass, composed of a positive conductive plate, a negative conductive plate, and ionic compound between the plates.

8. The method for rapidly changing the color of a light source as claimed in claim 6, further comprising applying the second or third voltage using the voltage converter to the light mask to generate an electromagnetic field (EMF) to change arrangement directions or ionization states of the ionic compound.

9. The method for rapidly changing the color of a light source as claimed in claim 6, wherein the voltage converter is a DC adjuster.

10. A computer-readable storage medium storing a computer program providing a method for rapidly changing the color of a light source, applied to an image apparatus, wherein the image apparatus comprises at least one light mask and one DC adjuster and the DC adjuster applies a first voltage to the light mask to show a first color, the method comprising using a computer to perform the steps of:
sending a control signal to the voltage converter; and
applying, using the DC adjuster, a second voltage greater than the first voltage to the light mask to show a second color or a third voltage less than the first voltage to the light mask to show a third color;

11. The computer-readable storage medium as claimed in claim 10, wherein the light mask is a piece of discoloration glass, composed of a positive conductive plate, a negative conductive plate, and ionic compound between the plates.

12. The computer-readable storage medium as claimed in claim 10, further comprising applying the second or third voltage using the DC adjuster to the light mask to generate an electromagnetic field (EMF) to change arrangement directions or ionization states of the ionic compound.
